(19) United States
(12) Patent Application Publication
(10) Pub. No.: US 2012/0215698 A1
(43) Pub. Date: Aug. 23, 2012

(54) Biologic-biometrics snapshot profile PIN access system

(76) Inventor: Robert Brown, JR., Warner Robins, GA (US)

(21) Appl. No.: 12/932,261

(22) Filed: Feb. 23, 2011

(51) Int. Cl. G06Q 50/00; H04L 9/32

(52) U.S. Cl. 705/50; 705/3

(57) ABSTRACT

The present biologic biometrics combination snapshot profile PIN access system is a global healthcare intervention invention for eliminating or reducing the decades of fear and risk for a doctor, or native or foreigner living in any local area, generally traveling, or a tourist within or outside of any city, state, or country have of being sick or injured and unable to speak or unconscious for a medical doctor under pressure for not having an opportunity provided for previewing the person or patient medical record or medical history in advance of administering medicine or performing operating procedure, that also can be used for reducing medical mal-practice, lowering medical mal-practice insurance costs, and decreasing medical mal-practice lawsuits, and also for other forms of life. The method includes obtaining the biologic biometrics combination snapshot profile representing the person or patient with access using PIN assignment 365 days per year, 24 hours per day anywhere on earth that also can be used in space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### TECHNICAL FIELD

This invention relates to an automated medical record system, and more particularly to biologic biometrics combination snapshot profile Personal Identifier Number access system for retrieving, updating, or transferring advance preview of current medication, current illness, DNA-blood type, and other patient vital medical data information on the basis of PIN access, assignment, and verification within minutes by the medical doctor making routine or emergency care and treatment decisions and diagnoses anytime anywhere on earth that also can be used in space station.

### BACKGROUND OF THE INVENTION

Like funds in the banking system for an account holder and bank teller making financial transaction using bank card assigned Personal Identifier Number access for withdrawing, depositing, or transferring anytime anywhere, person or patient biologic biometrics medical data information deposited in a combination snapshot profile PIN access system for retrieving an advance preview of person or patient current medication, current illness, DNA-blood type, or other patient vital medical data information by a medical doctor administering medicine or performing operating procedure for routine or emergency, anytime anywhere on earth that also can be used in space station.

People or patients sometimes have multiple medical operations and administered medicines diagnosed with warnings or precautions; man-hours involved for hospital release of information office delivery of medical record; duplicate lab tests and temporary delays found in patient care and treatment; doctors under pressure for making life or death treatment decision administering medicine or performing operating procedure without an advance opportunity of previewing the patient medical record or medical history prior to diagnosed care and treatment; body parts changes or surgical operations including implants, sex changes, or facial alterations manipulates visual identification during routine or emergency care or treatment; or doctor placed on hold until person or patient medical record or medical history validated or evaluated prior to a routine outpatient visit or emergency hospitalization procedure are dilemmas possibly faced. A doctor patient treatment time is hampered or wasted compared to tailored, quick, and responsive medical care treatment provided for the highest elected officials of any country; thus, equity is achieved in the present invention. Therefore, the present combination snapshot profile invention is responding to these situations, fears, or pressure; responding to current U.S. economic development challenge increasing employment rates, stimulating jobs growth; responding to the message and efforts of U.S. President Obama urging tax cuts, business innovators, and owners to stimulate the economy by creating jobs; and is development of a new system and methods for enhancing a disabled military veteran quality of life and lifestyle stimulating business development interests.

Any medical doctor connected to a medical care treatment facility encrypting console microprocessor or computer can be assigned PIN access to the central medical record transfer central hub center's space satellite or super computer data information storage bank, which stores the patient combination snapshot profile. Any person or patient prior to becoming sick or injured can be assigned a PIN for a doctor's use in accessing the combination snapshot profile having the current medication, current illness, DNA-blood type, and other vital medical data information for immediate use or future diagnoses. A PIN assigned to a person or patient can be indicated on for example: drivers license, vehicle roadside emergency card, social security card, auto insurance card, military identification or dog tag for quick photo reference, and is not intended to be limited to these restrictive personal security instruments. The combination profile PIN access system is a fee service $250-350 per snapshot profile request, collected or paid by the insurance company as an auto, home, or life, or any emergency roadside club membership plan, or direct personal payment.

### BRIEF SUMMARY OF THE INVENTION

The combination snapshot profile PIN access system is an opportune global healthcare intervention invention having a brief combination summary of any person or patient biologic biometrics data information composed in a snapshot profile with

PIN access anytime anywhere on earth that also can be used in space. Any medical doctor can be assigned a PIN connected to an assigned medical care treatment facility encrypting console microprocessor or computer. Any assigned medical care treatment facility encrypting console microprocessor or computer can be assigned a software installed PIN for accessing space satellite or super computer data information storage bank having a combination profile managed by the central medical record transfer hub center. The PIN assignment access person or patient combination snapshot profile having the current medicine, current illness, DNA-blood type, or other vital data information.

The combination snapshot profile PIN access system as disclosed, compliments the DoD Defense Biometrics Identification System, military dog tag and medical record transfer systems, Veterans Administration medical record keeping and transfer systems, and advances and surpasses these with logistics management science reducing medical mal-practice, medical mal-practice insurance costs, and medical mal-practice lawsuits for increasing medical care treatment facility doctor patient favorability rating; having a virtual paperless system with little to no maintenance required, no physical medical record to file or miss-file, little or no electronics components storage space costs for providing assist reducing budgetary line item costs for reducing the national deficit; furthermore, a PIN assignment can be extended to an animal or plant, thus a PIN assigned to a combination profile can be established for any form of life including any life cycle item. The combination snapshot profile PIN access system is linked to a space satellite and super computer that also can be used to link other world wonders, including consideration for general population living in space for linking anything, anytime everywhere.

### BRIEF DESCRIPTION OF THE DRAWINGS

FIG. 1 is a schematic diagram for a system for assigning a PIN access biologic biometrics for a person or patient of the present biologic biometrics combination snapshot profile PIN access system.

FIG. 2 is a flow chart for a method for an assigned PIN access biologic biometrics person or patient of the present biologic biometrics combination snapshot profile PIN access system.

### DETAILED DESCRIPTION OF THE PREFERRED EMBODIMENTS

Under ideal circumstances, system and methods early activation for immediate use is possible for doctors completing a configured console microprocessor or computer template for registering the person or patient combination snapshot profile having vital medical data information with the current or existing medication, current or existing illness, DNA-blood type, or other medical data information, in advance of the central electronic mail medical record transfer hub center establishing a space satellite or super computer data information storage bank. It is to be understood that the invention is not limited to the exact construction of method illustrated and described above, but that various changes and modifications may be made without departing from the spirit and scope of the invention as set forth in the following description:

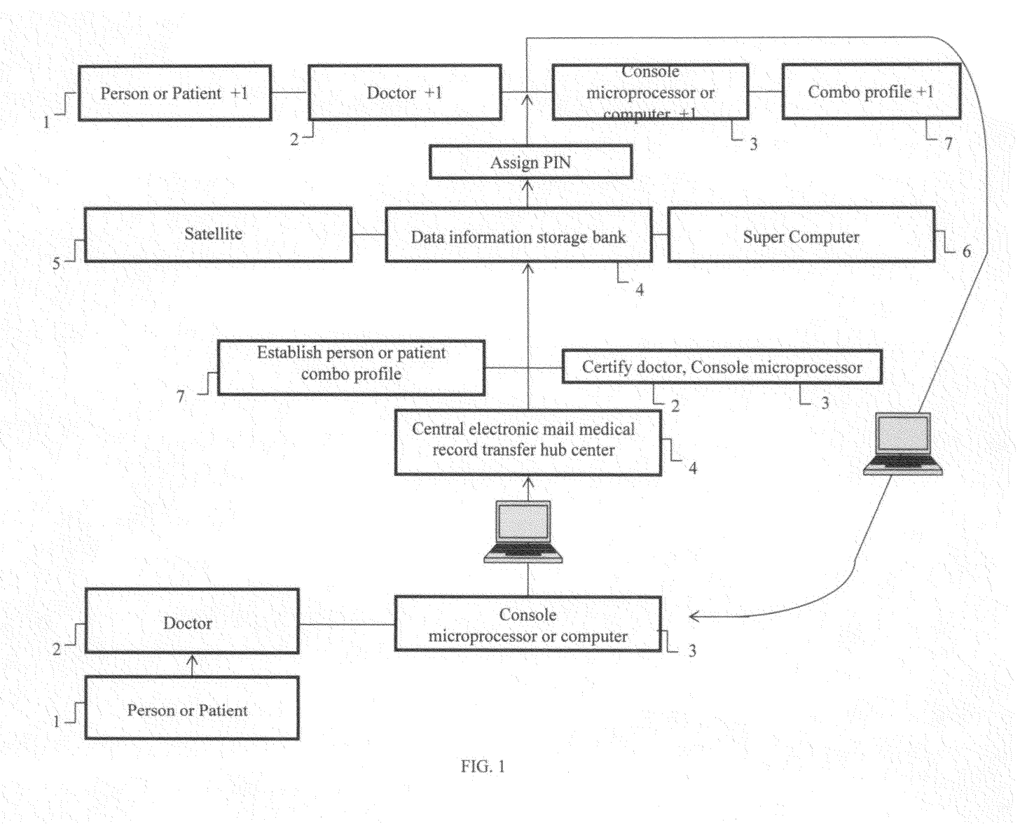

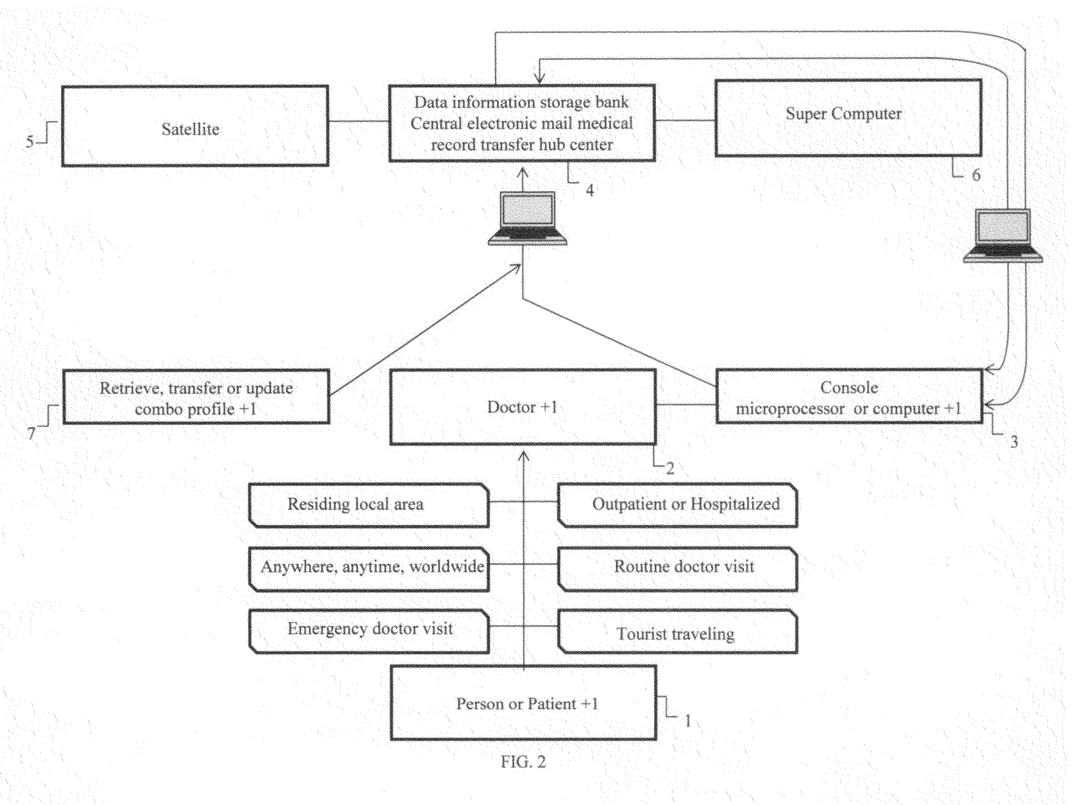

Referring to the chart FIG. 1-2, the core of the system according to the present invention is assignment of PIN, which can be carried by the person or patient 1, preferably directly on the body, and which preferably has been randomly assigned using a space satellite 5 or super computer 6. The PIN access combination profile system invented is shown and is generally designated by the reference +1.

FIG. 1, is a schematic illustration of establishing a PIN access combination profile process, according to a preferred embodiment of the present invention. Any person or patient 1 residing local area or tourist traveling within or outside of any city, state, or country, routine or emergency doctor visit, outpatient or hospitalized, anytime anywhere worldwide can request and can be assigned a PIN +1 by requesting through only a doctor 2 connected to a medical care treatment facility console microprocessor or computer 3. The PIN request is transmitted to the central electronic mail medical record transfer hub center 4 on letterhead stationery using a computer link. The central electronic mail medical record transfer hub center 4 establish or register the combination profile 7, and electronically file in the combination profile data information storage bank 4 connected to the space satellite 5 or super computer 6 which assigns a PIN +1. Simultaneously, the central electronic mail medical record transfer hub center 4 technician certify the person or patient 1, registering doctor 2, and medical care treatment facility console microprocessor or computer encrypting capability. The space satellite 5 or super computer 6 links and assigns the PIN assigned to the person or patient 1 to the combination profile 7; assigns a PIN to the doctor 2 connected to the console microprocessor or computer 3, and assigns a PIN to the doctor 2 assigned console microprocessor or computer 3 software with installation by the central electronic mail medical record transfer hub center 4 technicians. The combination profile 7 is encrypted dated the space satellite 5 or super computer 6 communicate back to the requesting doctor 2 console microprocessor or computer 3 PIN +1 assignment.

FIG. 2, is a flow chart illustration of an assigned PIN access combination profile process, according to a preferred embodiment of the present invention. The person or patient 1 +1 resides local area or tourist traveling within or outside of any city, state, or country, routine or emergency, outpatient or hospitalized, anytime anywhere worldwide; doctor 2 +1 connected to the medical care treatment facility console microprocessor or computer 3 +1, retrieves, updates, or transfers person or patient 1 +1 combination profile 7 +1 from central electronic mail medical record transfer hub center data information storage bank 4. The person or patient 1 +1 photo or other identification data information transmitted back for verification to doctor 2 console microprocessor or computer 3 from space satellite 5 or super computer 6 medical data information storage bank 4, anytime anywhere on earth.

I claim:

1. A global healthcare intervention system and method for updating, transferring, or retrieving a biologic biometrics combination snapshot profile by means of using PIN access, and PIN assignment, comprising:
a person or patient biologic biometrics identifying factors with PIN access;
a biologic biometrics combination snapshot composed in an electronic profile;
a medical doctor arranged to administer the biologic biometrics combination profile template registration of the reference combination snapshot profile information of the person or patient;
a medical care treatment facility console microprocessor or computer arranged to transfer the registered reference combination snapshot profiles of the person or patient, doctor identification with connection to console microprocessor or computer to a central electronic mail medical record transfer hub center;
a central electronic mail medical record transfer hub center establish the reference person or patient combination profile, request submitting doctor connection information to the console microprocessor or computer, and console microprocessor or computer software data information in the space satellite or super computer medical data information storage bank; and
a space satellite or super computer medical data information storage bank randomly assign matching PIN to person or patient and combination profile, assign doctor a PIN, and assign a software installed PIN to a doctor console microprocessor or computer.

2. The system and method of claim 1, wherein the combination profile comprises a person or patient snapshot of biologic biometrics medical data information.

3. The system and method of claim 2, further comprising the biologic biometrics combination snapshot profiles current medicine, current illness or injury, DNA-blood type, body identifier, or other vital medical data information.

4. The system and method of claim 1, wherein the PIN assignment comprises a drivers license, vehicle roadside emergency card, social security card, auto insurance card, military identification, or dog tag.

5. The system and method of claim 1, wherein the medical doctor assigned encrypting console microprocessor or computer registers person or patient.

6. The system and method of claim 5, further comprising the central electronic mail medical record transfer hub center assigns encrypting console microprocessor or computer.

7. The system and method of claim 6, wherein the technician installs and assigns encrypting console microprocessor or computer.

8. The system and method of claim 7, further comprising the PIN assignment alpha or numeric character or combination alpha and numeric character.

9. The system and method of claim 1, wherein the space satellite or super computer assign and verify PIN assignment.

10. The system and method of claim 1, wherein the medical doctor assigned encrypting console microprocessor or computer updates, transfers, or retrieves combination snapshot profile.

11. The system and method of claim 10, further comprising the person or patient combination profile template constructs biologic biometrics data information.

12. The system and method of claim 11, wherein the PIN assignment reduce medical mal-practice, medical mal-practice doctor insurance costs, and medical mal-practice lawsuits increasing medical care treatment facility doctor-patient favorability rating.

13. The system and method of claim 12, further comprising the reduced line items total budget expenses.

14. The system and method of claim 1, wherein the PIN assignment reduce or eliminate medical treatment delay.

15. The system and method of claim 1, wherein the PIN assignment for a person or patient, doctor, or assigned encrypting console microprocessor or computer.

16. The system and method of claim 1, wherein the space satellite or super computer store, retrieve, update, or transfer medical data information.

17. The system and method of claim 1, wherein the PIN assignment eliminate or reduce person or patient and doctor risk, pressure, and fear.

18. The system and method of claim 17, further comprising the PIN assignment assists patient and doctor diagnoses sick or injured and unconscious or unable to speak.

19. The system and method of claim 18, wherein the doctor assigned PIN accesses diagnoses support.

20. The system and method of claim 1, wherein the PIN assignment any form of life.
